(19) United States
(12) Patent Application Publication
(10) Pub. No.: US 2009/0132346 A1
(43) Pub. Date: May 21, 2009

(54) Modifying Broadcast Media Ad Campaigns

(75) Inventors: Jagpreet S. Duggal, Seattle, WA (US); Davi K. Robison, New York, NY (US); Kristin K. Nagata, Irvine, CA (US); Robert D. Gardner, Irvine, CA (US); Alexandr Y. Smolyanov, Rancho Santa Margarita, CA (US); Weizhao Wang, Irvine, CA (US); Russell K. Ketchum, Newport Beach, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/267,392

(22) Filed: Nov. 7, 2008

Related U.S. Application Data
(60) Provisional application No. 60/986,231, filed on Nov. 7, 2007.

(51) Int. Cl. G06Q 30/00; G06Q 10/00

(52) U.S. Cl. 705/10; 705/14

(57) ABSTRACT

Among other things, methods, computer program products, and systems can be used to modify a previously booked broadcast media ad campaign. For example, an previously booked broadcast media ad campaign can be modified by selecting one or more parameters from among multiple parameters associated with the previously booked broadcast media ad campaign. The selected one or more parameters are modified, and the modified one or more parameters are applied to the previously booked broadcast media ad campaign while the previously booked broadcast media ad campaign is still running.

### CLAIM OF PRIORITY

This application claims priority under 35 USC §119(e) to U.S. Patent Application Ser. No. 60/986,231, filed on Nov. 7, 2007, the entire contents of which are hereby incorporated by reference.

### TECHNICAL FIELD

The present disclosure relates to broadcast media ad campaigns.

### BACKGROUND

A radio ad campaign can be designed to broadcast one or more broadcast media ads on one or more broadcast stations over a period of time. An ad can also be designed to captivate the listener's attention and motivate the listener to perform an act, such as purchasing a product, viewing a website, or calling a phone number. An advertiser can purchase blocks of air time, or ad spots in order to broadcast the designed ads.

### SUMMARY

Techniques for modifying broadcast ad campaigns are disclosed. In one aspect, enabling an advertiser to modify a previously booked ad campaign includes selecting from among multiple parameters associated with a previously booked ad campaign. A previously booked ad campaign includes those campaigns that have been previously created and booked but may or may not be active and running when modifications are made. The selected one or more parameters are modified, and the modified one or more parameters are applied to the previously booked ad campaign while the previously booked ad campaign is running.

Implementations may optionally include one or more of the following features. The selected one or more parameters may be selected from a group that includes a geographic market, a station format type, a campaign duration, a time interval of the campaign, a time spot, a day spot, a station tier type, and a target demographic. The selected one or more parameters can be modified without releasing one or more reserved ad spots in a reservation ad campaign. Alternatively, the modified one or more parameters can be applied in an auction campaign. In addition, a desired number of estimated ad listeners to be captured by the previously booked ad campaign can be determined. A percentage of the determined desired number of estimated ad listeners can be assigned to each of the parameters. The desired number of estimated ad listeners may be assigned based on a uniform weighting system. Furthermore, a budget for the previously booked ad campaign can be obtained. The obtained budget is modifiable to increase or decrease the desired number. Also, the desired number can be redistributed among the one or more parameters based on one or more rules. In addition, one or more reports can be generated to describe at least the percentage of the desired number assigned to each of the parameters.

In another aspect, techniques described in this specification are implemented as a computer program product that enables ad campaign modification. The computer program product is designed to cause a data processing apparatus to perform operations including selecting one or more from multiple parameters associated with a previously booked ad campaign. The computer program product is also designed to modify the selected one or more parameters, and apply the modified one or more parameters to the previously booked ad campaign while the previously booked ad campaign is running.

Implementations may optionally include one or more of the following features. The computer program product can be designed to cause the data processing apparatus to select one or more of the parameters from a group that includes a geographic market, a station format type, a campaign duration, a time interval of the campaign, a time spot, a day spot, station tier type, and a target demographic. In addition, the computer program product can also be designed to cause the data processing apparatus to modify the selected one or more parameters without releasing one or more reserved ad spots in a reservation ad campaign. Alternatively, the computer program product can be designed to cause the data processing apparatus to applying the modified one or more parameters in an auction campaign. Further, the computer program product can be designed to cause the data processing apparatus to determine a desired number of estimated ad listeners to be captured by the previously booked ad campaign and assigning a percentage of the desired number to each of the parameters. The desired number may be assigned based on a uniform weighting system. Also, the computer program product can be designed to obtain a budget for the previously booked ad campaign, with the budget being modifiable to increase or decrease the desired number. In addition, the computer program product can be designed to cause the data processing apparatus to perform operations including, when detected that one or more of the ad parameters are modified, redistributing the desired number among the one or more parameters based on one or more rules Also, the computer program product can be designed to cause the data processing apparatus to generate one or more reports that describe at least the percentage of the desired number assigned to each of the parameters.

In another aspect, the techniques described in this specification are implemented as system of modifying a previously booked ad campaign. The system includes a user interface and one or more computers coupled to the user interface. The one or more computers include a display and a processor configured together and designed to provide a graphical user interface. The graphical user interface includes a parameter selector designed to receive a user selection of one or more parameters from multiple parameters associated with a previously booked ad campaign. The graphical user interface also includes a parameter modification region designed to receive a user modification of the selected one or more parameters. The one or more computers are also designed to apply the received user modification to the previously booked campaign while the previously booked campaign is running.

Implementations may optionally include one or more of the following features. The one or more computers can be designed to provide the parameter selector to enable user selection of one or more parameters from a group that includes a geographic market, a station format type, a campaign duration, a time interval of the campaign, a time spot, a day spot, station tier type, and a target demographic. Also, the one or more computers can be designed to provide the parameter modification region to enable user modification of the selected one or more parameters without releasing one or more reserved ad spots. Alternatively, the one or more computers can be designed to apply the received user modification in an auction ad campaign. The one or more computers can also be designed to determine a desired number of estimated ad listeners to be captured by the previously booked ad campaign and assign a percentage of the desired number to each parameter. The desired number may optionally be assigned based on a uniform weighting system. Further, the one or more computers can be designed to provide the parameter selector to receive a user selected budget for the previously booked ad campaign. The user selected budget is modifiable to increase or decrease the desired number. In addition, the one or more computers can be designed to redistribute the determined desired number among the parameters based on one or more rules. Also, the one or more computers can be designed to generate one or more reports that include information concerning the percentage of the desired number assigned to each parameter.

In another aspect, a ad campaign modification system is provided that includes a display means for presenting a graphical user interface operable to receive a user selection of one or more parameters from a plurality of parameters associated with a previously booked ad campaign and a processing means for modifying the selected one or more parameters and applying the modified one or more parameters to the previously booked ad campaign while the previously booked ad campaign is running.

The subject matter described in this specification may provide one or more advantages. For example, enabling an advertiser to modify a previously booked ad campaign while it is still running means that modifications can quickly be applied. In addition, the reserved ad spots do not need to be released in order to reconfigure the previously booked ad campaign with new ad spots, eliminating the risk of losing the ad spots to another campaign.

The subject matter described in this specification can be implemented as a method or as a system or using computer program products, tangibly embodied in information carriers, such as a CD-ROM, a DVD-ROM, a semiconductor memory, and a hard disk. Such computer program products may cause a data processing apparatus to conduct one or more operations described in this specification.

In addition, the subject matter described in this specification can also be implemented as a system including a processor and a memory coupled to the processor. The memory may encode one or more programs that cause the processor to perform one or more of the method acts described in this specification.

The details of one or more implementation are set forth in the accompanying drawings and the description below. Other features, aspects, and advantages will be apparent from the description and drawings, and from the claims.

### DESCRIPTION OF DRAWINGS

FIG. 1 is a system diagram depicting an ad campaign booking system.

FIG. 2A is a process flow diagram illustrating an ad campaign process from the view of an advertiser.

FIG. 2B is a process flow diagram illustrating a parameter modification process.

FIG. 2C is a process flow diagram illustrating a redistribution process.

FIG. 3 is an illustration of a graphical user interface.

FIG. 4 is an illustration of a graphical user interface section pertaining to a budget.

FIG. 5 is an illustration of a graphical user interface section pertaining to markets.

FIG. 6 is an illustration of a graphical user interface section pertaining to an estimator.

FIG. 7 is an illustration of a graphical user interface section pertaining to a report generator.

FIG. 8 is an illustration of a played spots report.

FIGS. 9a and 9b are illustrations of exemplary summary reports.

FIG. 10 is an illustration of the use of overflow rates in impression distribution.

FIG. 11 is an illustration of a graphical user interface that enables selection of an overflow rate.

Like reference symbols and designations in the various drawings indicate like elements.

### DETAILED DESCRIPTION

For illustrative purposes, examples in this specification are described with respect to radio broadcasts. However, the techniques, systems and computer program products described in this specification are equally applicable to other broadcast media including A.M. radio, F.M. radio, satellite radio, internet radio, podcasts, cellular phone multicasts, digital television multicasts, etc.

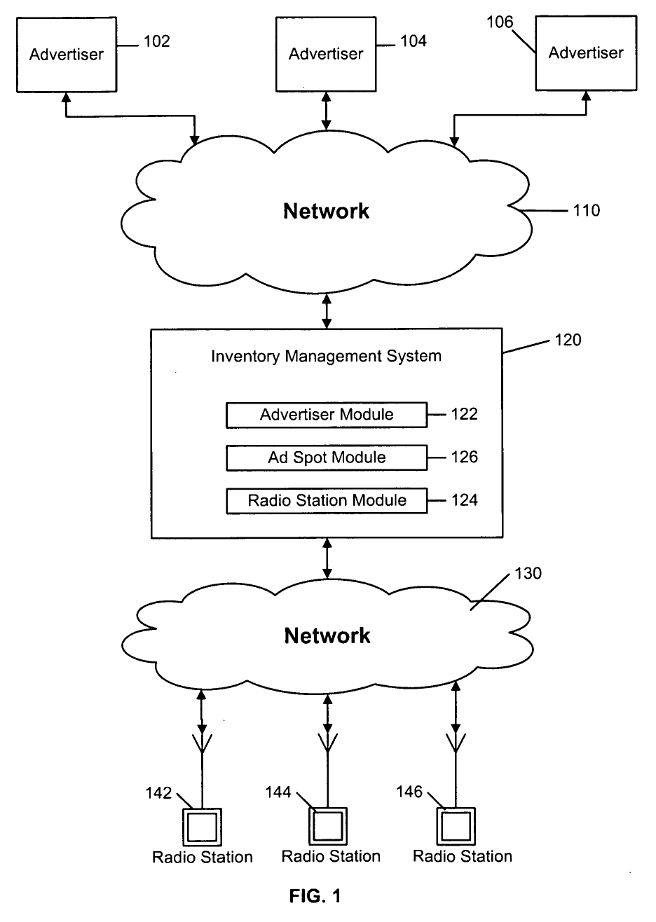

FIG. 1 depicts an example broadcast ad campaign system. One or more advertisers 102, 104, and 106 in the front end of the system are communicatively connected, through a network 110, to a back end computer system that includes an ad inventory management system 120. The advertisers 102, 104, and 106 in the front end interfaces with one or more data processing devices (e.g., a personal computer, a mobile computing device, a network terminal, etc.) to provide data input concerning a broadcast ad campaign. The data input received from the front end is processed by the ad inventory management system 120 in the back end by using one or more software modules. The ad inventory management system 120 contains various software modules including an advertiser module 122, a broadcast station module 124, and an ad spot module 126. The ad inventory management system can be implemented to as a server in communication with the advertisers 102, 104, and 106 in the front end. The network 110 includes a dedicated network such as a local area network (LAN) and a wide area network (WAN). Alternatively, the network 110 can include an open network such as the internet. Connections to the network 110 can be enabled using a wired or wireless communication link. The wired connection can include Universal Serial Bus (USB), firewire, serial, parallel, etc. The wireless connection can include Bluetooth, Wifi, Wimax, infrared, etc. The ad inventory management system 120 is communicatively connected, through another network 130, to one or more broadcast stations 142, 144, and 146. The network 130 can be implemented substantially the same as the network 110.

In some implementations, other system configurations are possible. For example, the one or more advertisers 102, 104, and 106, the ad inventory management system 120, and the one or more broadcast stations 142, 144, and 146, may all be communicatively connected through the same network (i.e., networks 120 and 130 can be implemented using the same network.). In addition, the various software modules can be implemented as one integrated software module.

The ad inventory management system (IMS) 120 is designed to receive information regarding available ad spots from each of the one or more broadcast stations 142, 144, and 146. The received information is processed by the broadcast station module 124. The ad inventory management system 120 can also be designed to relay the received information regarding the available ad spots to the one or more advertisers 102, 104, and 106 using the advertiser module 122. Each of the one or more advertisers 102, 104, and 106, may send the advertiser module 122 information concerning one or more broadcast ads to be broadcasted and information regarding the advertiser selected ad spots from the available ad spots. The advertiser module 122 is designed to receive this information, communicate with the ad spot module 126 to purchase the selected ad spots, and send the ad and ad spot information to the one or more broadcast stations 142, 144, and 146 to broadcast. The advertiser module 122 and broadcast station module 124 may request updates from the one or more advertisers 102, 104, and 106 and from the one or more broadcast stations 142, 144, and 146.

While the remainder of the specification refers mainly to advertiser 102, any discussion regarding advertiser 102 is also representative of advertisers 104, 106, or any other advertiser.

The advertiser 102 can optionally elect to run an auction campaign, a reserve campaign, or a combination of both. An auction campaign option enables the advertiser 102 to bid on ad spots using one or more auction formats similar to those used to purchase fungible goods. A reserve campaign option enables the advertiser 102 to purchase one or more desired ad spots directly. An auction campaign may be less expensive and may generally be a good option, among other reasons, for ad campaigns that are not time-sensitive. A reserve campaign may be more expensive than an auction campaign, but may be a good option, among other reasons, for time-sensitive ad campaigns, such as Valentine's Day ads.

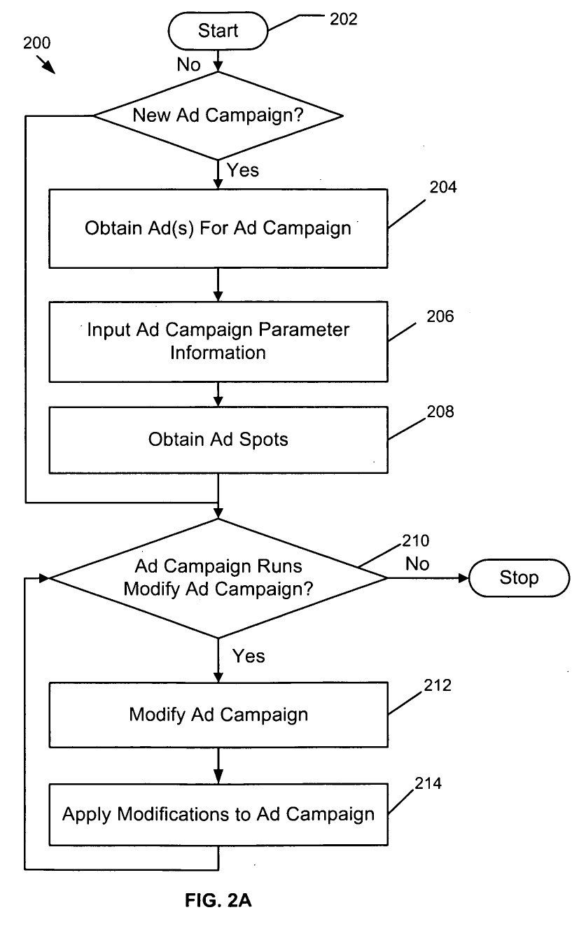

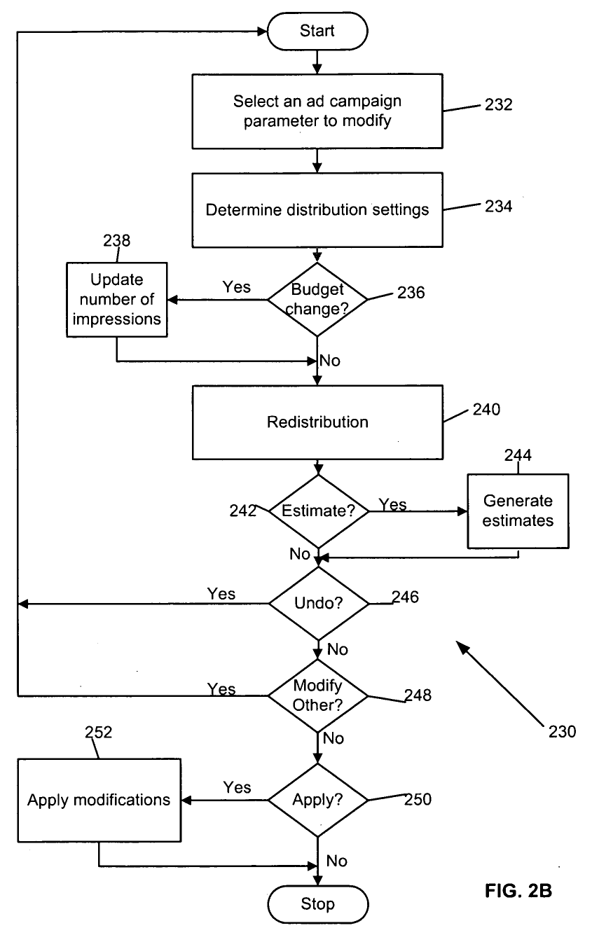

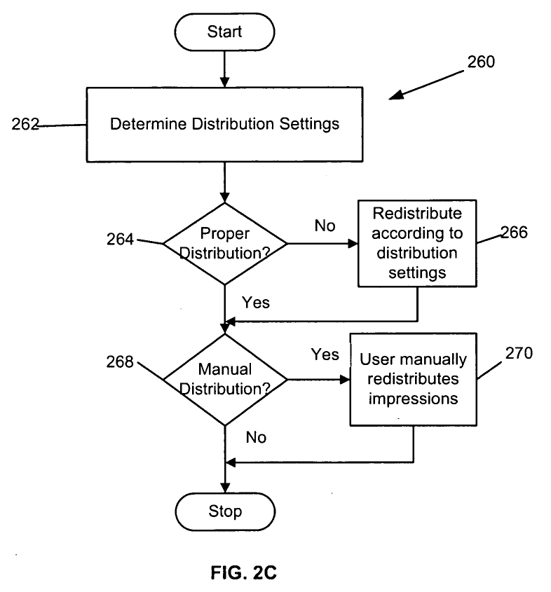

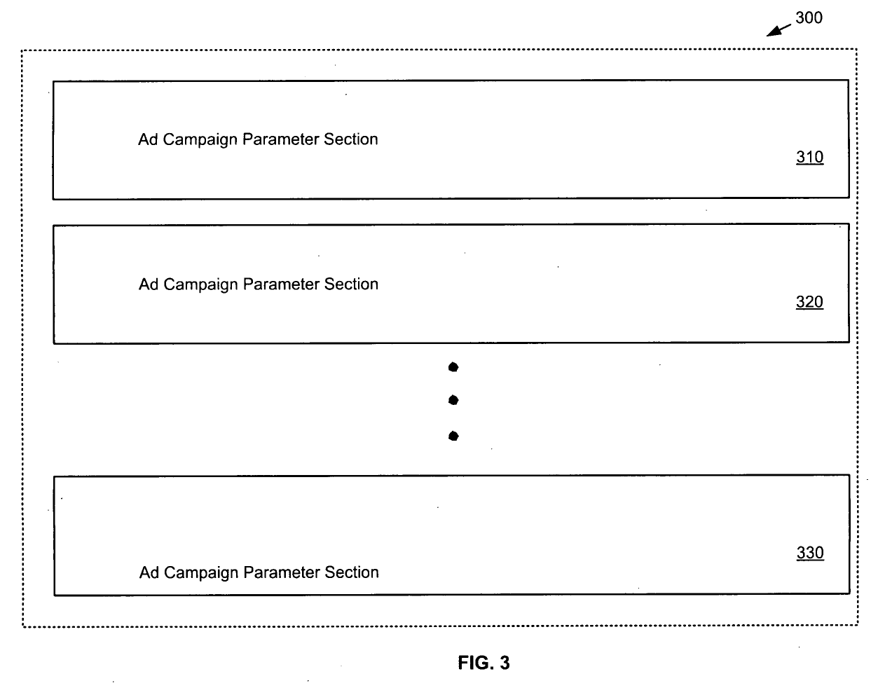

FIG. 2A depicts a process flow diagram that illustrates an exemplary process 200 for creating and/or modifying an ad campaign. The advertiser 102 interfaces with a data processing device at the front end and provides data input regarding an ad campaign to be created or modified. At the data processing device, a graphical user interface can be presented to the advertiser 102 to enable the advertiser 102 to obtain information and input data regarding an ad campaign. The graphical user interface is described further with respect to FIGS. 3-9.

The advertiser determines, at 202, whether to modify a previously booked campaign (e.g., a previously created) or a start a new campaign. When determined that a new campaign should be started, the advertiser 102 obtains, at 204, one or more ads that it wants to broadcast over one or more broadcast media.

At 206, the advertiser 102 can obtain and review information regarding available ad spots and input data regarding parameter information to use in determining which available ad spots to purchase. These ad parameters may include, but are not limited to: geographic markets, station format types, broadcast stations, campaign durations, campaign time intervals, time spots (e.g., specific time of a day, such as 10 AM), day spots (e.g., specific day or days of the week), target demographic, budget, and a combination of two or more parameters. An example of a parameter combination includes selecting a combination of a time spot and a day spot (e.g., a 10 AM spot every Tuesday and Thursday.) Further, broadcast stations can be selected based on the designated tier. For example, a radio station maybe designated as tier one, tier two, tier three, etc. based on the number of listeners captured by that station. The top tier (e.g., tier one) stations are the highest rated (most listeners) stations, and the bottom tier (e.g., tier three or lower) stations are the lowest rated (fewer listeners) stations.

When determining which available ad spots to purchase, the advertiser 102 provides information regarding the desired number of broadcast ad listeners that the ad campaign should capture (i.e., the ones that the advertiser wants to listen to its ads.) This desired number of broadcast ad listeners is also known as the number of impressions. In response to information received from the advertiser, the advertiser module 122 may generate impression estimates that each ad spot can provide so that the ad spots can be allocated according to the desired number of impressions. The number of impressions are distributed among the ad parameters to enable the advertiser 102 to better optimize its ad campaign. When determining the number of impressions, the advertiser takes into account the reach and frequency of an ad spot. The reach is the estimated number of listeners who will hear the advertiser's 102 one or more ads during a given amount of time and the frequency is the number of times each listener will hear the one or more ads during a given amount of time.

At 208, the advertiser 102 purchases ad spots based on the ad parameters provided at 206. The advertiser 102 sends the one or more ads that it wants broadcasted, as well as purchasing information for the desired ad spots, to the advertiser module 122 through the ad inventory management system 120. The advertiser module 122 purchases the ad spots in conjunction with the ad spot module 126 and sends the one or more ads to the one or more broadcast stations 142, 144, and 146 through the broadcast station module 124. The ad spots may be automatically purchased according to the parameters inputted by the advertiser 102, or the advertiser 102 may manually select the ad spots that it wants to purchase. The one or more ads can then be broadcasted during the purchased ad spots.

At 210, the advertiser 102 observes and receives information about a previously booked (either active/ongoing or not yet active) ad campaign. The booked ad campaign can include any one of the ad campaign that the advertiser has already created and booked. This information may include statistical data such as the actual number of impressions obtained by previously played ad spots, an updated estimate of the number of impressions to be obtained by future ad spots, and data regarding purchasing trends as affected by the ad campaign. At this point, the advertiser 102 may decide to modify any one of the previously booked ad campaigns. A previously booked ad campaign can be modified in order to increase efficiency, change the target listeners, reduce the campaign size, etc. For example, the advertiser 102 may analyze the data and realize that a particular market is underperforming and may modify the parameters of that particular market or remove the market from the ad campaign altogether.

At 212, the advertiser 102 may make modifications to one or more of the previously booked ad campaigns to increase efficiency, for example. The advertiser 102 may want to substitute new ads or change the parameters. For example, the advertiser 102 may want to make modifications such as adding or removing markets, station formats, stations, day spots (e.g., days of week or DOW), and time spots (e.g., dayparts such as AM drive, Afternoon, and PM Drive). The advertiser 102 may also want to change the duration of the previously booked ad campaign by adjusting the start and end dates of the campaign. The advertiser 102 may also want to adjust the previously booked ad campaign according to a flight, or time interval of the campaign. Thus, the previously booked ad campaign may run according to different parameter settings during the first half of the previously booked ad campaign than the second half of the previously booked ad campaign. The advertiser 102 may also want to modify the target demographic of the campaign, taking into account the gender, age, ethnicity, occupation, and religious beliefs of the target audience. Further, the advertiser 102 may also modify the distribution settings to choose even distribution, weighted distribution, etc. Also, the advertiser 102 may increase or decrease the budget.

At 214, the modifications to the ad campaign are applied while the campaign is still running and/or without releasing previously purchased ad spots. Thus, any modifications to the ad campaign can quickly be applied. If the advertiser 102 were to release the previously purchased ad spots, the advertiser 102 may run the risk of not being able to re-obtain those particular ad spots because another advertiser may quickly acquire those ad spots. New ad spots can be obtained according to the modifications and any unnecessary or undesired ad spots can be released. The advertiser 102 can return to 210 to evaluate the effects of the modifications and to make further modifications if desired. Also, the advertiser can modify any other previously booked ad campaigns.

FIG. 2B illustrates a process flow diagram of a process for modifying one or more previously booked ad campaigns. In some implementations, the process described in FIG. 2B may further enable the process described with respect to FIG. 2A, at 212 and 214, where the advertiser modified parameters are applied to the previously booked ad campaign while the previously booked ad campaign is active (still running). At 232 the advertiser 102 selects one or more of the parameters, associated with an previously booked ad campaign, to modify. Modifications may include adding or removing markets, station formats, stations, day spots (e.g., days of week or DOW), and time spots (e.g., dayparts such as AM drive, Afternoon, and PM Drive). The advertiser 102 may also want to change the duration of the ad campaign by adjusting the start and end dates of the previously booked ad campaign. The advertiser 102 may also want to adjust the previously booked ad campaign according to a flight, or time interval of the previously booked ad campaign. Thus, the previously booked radio ad campaign may run according to different parameter settings during the first half of the previously booked ad campaign than the second half of the previously booked ad campaign. The advertiser 102 may also want to modify the target demographic of the previously booked ad campaign. Further, the advertiser 102 may also modify the distribution settings to choose based on rules describe below, such as even distribution, weighted distribution, etc. Also, the advertiser 102 may increase or decrease the budget. Modifications may incur cancellation penalties which may be factored into the budget.

At 234, the advertiser module 122 determines the distribution settings to use. The user settings are composed of one or more rules that govern the distribution of impressions among the parameters. The one or more rules may be specified by the user or may be inherent to the advertiser module 122. For example, if the parameter is the geographic market, the impressions may be distributed among the different geographic markets, such as Bakersfield, Chino, Fresno-Visalia, Los Angeles, Monterey-Salinas, and Palm Springs. One rule may be that impressions are distributed first from removed markets to added markets and then the impressions are redistributed among all the markets. Another rule may be that the impressions are distributed according to a uniform weighting system, meaning that the impressions are distributed evenly among the parameters. Another possible weighting system includes assigning a percentage of the desired number of impressions to each market according to market size. Another possible weighting system includes assigning a percentage of the desired number of impressions to each market according to market size and to include an overflow rate. Overflow rates are discussed below. The advertiser 102 may also implement its own customized weighting system.

Determining the distribution setting 243 can also include applying these and/or other redistribution rules based on the modification of the one or more campaign parameters. For example, when the one or more of the campaign parameters are modified to add a new geographical market and none of the original geographical markets are removed, the system (e.g., IMS 120) can re-distribute the remaining impressions from original markets to apply uniform distribution to the newly added markets for the remainder of the schedule (where inventory permits). When one or more new markets are requested to be added by the advertiser 102, and one or more original markets are requested to be removed, the system can re-distribute impressions from the removed markets to the newly added markets first, to the extent that an uniform distribution can be achieved. Any additional impressions remaining can then be added across all markets (original and new markets) evenly, as necessary and according to overflow, to optimize the desired budget.

When the advertiser 102 requests to add one or more new geographical markets and increase the budget to accommodate, the additional impressions based on the added budget is distributed evenly across the new markets only, according to overflow. All other original campaign parameters remain intact. In such implementations, disproportionate amount of inventory may be assigned in the new markets when compared to the original markets. The degree of disproportional distribution may depend on the amount of budget increase and the remaining inventory to deliver in the original markets. Alternatively, the advertiser 102 may request to add one or more new markets and increase the overall budget to accommodate the added markets. In addition, the advertiser 102 may choose to increase the buy in original markets. In such implementations, the system can first bring new markets into uniform distribution with original markets, and then add additional inventory evenly across all markets, according to overflow, to satisfy new budget.

Redistribution of impressions by market size can be performed based on one or more various rules. For example, when a new market is requested by the advertiser 102, and none of the original markets are removed, the system can re-distribute remaining impressions from original markets to apply a weighted distribution to the newly added markets. The weighed distribution can be proportional to market size and according to overflow. When one or more new markets are requested by the advertiser 102, and one or more original markets are requested to be removed, the system can first re-distribute impressions from the removed markets to the new markets to the extent that the re-distribution results in a distribution proportional to market size. Additional impressions available can then be added across all markets (original and new), according to market size and overflow, in order to satisfy original budget.

When the advertiser 102 adds one or more new markets and increases the budget to accommodate the added markets, the additional impressions based on the added budget can be distributed proportionally to market size across the newly added markets only, according to overflow. All other original campaign parameters remain intact. Such distribution scheme may result in a disproportionate distribution of inventory (impressions) across the new markets and the original markets. The amount of disproportional distribution may depend on the amount of budget increase and the remaining inventory to be delivered in the original markets.

In some implementations, the advertiser 102 may request to add one or more new markets and increases the overall budget to accommodate the added new markets. In addition, the advertiser 102 may also request re-upping the buy in original markets. In such implementations, the system can first bring new markets into proportional distribution with original markets, and then add additional inventory proportionally across all markets, according to overflow, to satisfy re-upped budget.

When the advertiser 102 requests to remove one or more markets, and no new markets are added, the system can add impressions evenly across all remaining markets to absorb the impressions from the deleted markets. Overflow parameters can be applied to guide the re-distribution of the displaced impressions only. A default overflow parameter (e.g., 9999%) can be implemented with an option to input a desired overflow value (e.g., X %.) Impressions that can not be re-distributed due to overflow constraint or lack of inventory can lead to a reduction in the actual budget. In such implementations, partial cancellation penalties may apply.

When the advertiser 102 requests to remove one or more markets and add one or more new markets, the system can re-distribute impressions from the removed markets to the new markets first, to the extent that the redistribution results in an uniform distribution. Any additional impressions remaining can be then added across all markets evenly, as necessary and according to overflow, to achieve the desired budget. Impressions that can not be re-distributed due to overflow constraint or lack of inventory may result in a reduce budget. In such instance, partial cancellation penalties may apply. Alternatively, the advertiser 102 may request to remove one or more markets without re-distributing the displaced impressions (those that were assigned to the removed markets). In such instances, all other remaining original markets are retained, and the budget is reduced accordingly (based on the removed markets). Again, in such implementations, partial cancellation penalties may apply.

When the advertiser requests to remove one or more markets without adding any new markets, the system can re-distribute the impressions from the removed markets across the remaining original markets. The re-distribution can be proportional to market size and according to overflow. Overflow parameters specified by the advertiser 102 at the time of the modification can guide the re-distribution of displaced impressions only. A default overflow parameter (e.g., 9999%) can be implemented with an option to input a desired overflow value (e.g., X %.) Impressions that can not be re-distributed due to overflow constraint or lack of inventory may lead to a reduction in the achieved budget. In such instances, partial cancellation penalties may apply.

When the advertiser requests to remove one or more markets without adding any new markets, the system can first re-distribute the displaced impressions from the removed markets to the new markets, to the extent that the redistribution results in appropriately weighted distribution for the newly added market size. Any additional impressions available can then be added across all markets according to market size, as necessary and according to overflow, to achieve the desired budget. Impressions that can not be re-distributed due to overflow constraint or lack of inventory may lead to a reduction in the realized budget. In such instances, partial cancellation penalties may apply.

In some implementations, advertiser 102 may request to remove one or more markets without re-distributing the displaced impressions from the removed markets. In such modifications, all other markets are retained, and the realized budget is reduced accordingly based on the impressions that were assigned to the removed markets. In such instances, partial cancellation penalties may apply.

In addition, the advertiser may be provided with an option to apply a weight distribution either by daypart and market or daypart and format. Such option may also include a modifiable format overflow parameter to apply overflow to the format. For example, when the advertiser 102 requests to add a new format without removing any of the original formats, the system can re-distribute remaining impressions evenly across the original and new formats, according to overflow. A default overflow (e.g., 9999%) can be provided to the advertiser 102, with an option for the advertiser 102 to specify a overflow parameter.

When the advertiser 102 requests adding one or more new formats and removing one or more of the original formats, the system can first re-distribute the displaced impressions from the removed format to the new formats, to the extent that the re-distribution results in an uniform distribution. When the number of displaced impressions exceed available inventory in the newly added formats, additional impressions can be spread evenly across all formats (new and original). Impressions that can not be re-distributed due to overflow constraint or lack of inventory may lead to a reduction in the realized budget. In such instances, partial cancellation penalties may apply. When the advertiser requests to remove one or more of the original formats without adding any new formats, the system can re-distribute the displaced impressions from the removed formats evenly across the remaining original formats. Impressions that cannot be re-distributed due to lack of inventory may lead to a reduction in the realized budget. In such instances, partial cancellation penalties may apply.

In some implementations, the advertiser 102 may request to add one or more new formats and increase the budget to accommodate for the added formats. Any additional impressions due to the increased budget can be distributed evenly across the new formats only, and any applied overflow parameters are applied only to the redistribution of impressions to the new formats. All other campaign parameters remain intact. Alternatively, the advertiser 102 may request to add one or more new formats and increase the overall budget. Also, the advertiser 102 may request increased impressions for the original formats as well. The added impressions due to the increased budget can be used to first bring new formats into proportional distribution with remaining impressions on original formats. Then any additional inventory available can be distributed across all formats (new and original) evenly, according to overflow, to satisfy increased budget. Alternatively, the advertiser 102 may request to remove one or more formats and reduce the budget to accommodate for the removed formats. All other campaign parameters remain intact. In such implementations, partial cancellation penalty may apply.

Determining the distribution setting 243 can also include applying these and other redistribution rules when modifying the one or more campaign parameters includes adding one or more broadcast stations. A simple reservation scheme includes enabling the advertiser 102 to add one or more b broadcast stations using format or market as a proxy. The default rules and options respective to the proxy apply in such implementations. Alternatively, an advanced scheme includes one or more of the following: When an uniform distribute by impressions is requested by the advertiser, any remaining impressions are re-distributed evenly by market to accommodate the newly added stations. When detected that a distribute by market size is requested, the system can redistribute any remaining impressions proportionally based on the market size of each market to accommodate the newly added stations. Alternatively, the advertiser may request to add one or more stations and increase the overall budget to accommodate for the added stations. Also, the advertiser 102 can re-up (i.e., increase) the impressions allocated to the original stations. The additional impressions due to the increased budget are first used to bring new stations into proportional distribution with remaining original stations. Then any remaining additional inventory is added across all stations (new and original) according to distribution and overflow settings, to satisfy re-upped budget.

Alternatively, the advertiser 102 may add one or more stations and increase the budget to accommodate for the added stations. The additional impressions due to the increased budget can be distributed either (a) evenly across new stations only, when uniform distribution by impression is requested, or (b) proportionally to market size of new stations only, when distribution by market size is requested. All other campaign parameters remain unchanged. In such instances, a disproportionate market distribution may result.

Determining the distribution setting 243 can also include applying these and other redistribution rules when modifying the one or more campaign parameters includes removing one or more stations. A simple reservation scheme includes enabling the advertiser 102 to remove one or more stations using format or market as a proxy. In such instances, the default rules and options respective to the proxy apply.

Alternatively, when detected that an uniform distribution by impressions is requested, the displaced impressions from the removed stations are re-distributed evenly across the remaining markets to accommodate the removed stations. When detected that an uniform distribution by market size is requested, the displaced impressions from the removed stations are re-distributed proportionally to the remaining markets by the market size of the remaining markets. When detected that the advertiser 102 has requested to remove one or more stations and decrease the budget accordingly, the system can hold reservations on all other stations. In such implementations, partial cancellation penalty may apply.

Determining the distribution setting 243 can also include applying these and other redistribution rules when modifying the one or more campaign parameters includes changing dates of the ad campaign. For example, when the advertiser extends the end date of the ad campaign without increasing the overall budget, the system can re-distribute remaining impressions (a) evenly or (b) proportionally based on market size, across all specifications and according to overflow to fill in the new delivery period.

When the advertiser 102 extends the end date of the ad campaign and increases the budget, the system can hold the current reservations, and add additional impressions (a) evenly or (b) proportionally based on market size, across all specifications and according to overflow. The re-distribution is applied first to new dates and then across total remaining campaign period to achieve appropriately balanced (uniform) distribution. When the advertiser requests to move the start date forward (applicable to previously booked but not yet active campaigns) in time, all original reservations are held, and the displaced impression from the late start date can be added across the remaining period, according to distribution settings and overflow, to retain the original budget. Alternatively, the advertiser may request to extend the start or end dates by adding a flight. In such implementations, the default rules (further described below) and options for changing the flights apply.

Determining the distribution setting 243 can also include applying these and other redistribution rules when modifying the one or more campaign parameters includes changing one or more flights The default rule is when the advertiser 102 requests to add one or more flights without deleting one or more original flights, the overall budget is increased accordingly. All other flights are retained. Alternatively, when the advertiser 102 requests to delete one or more of the original flights without adding any new flights, the overall budget is reduced accordingly. All other remaining flights are retained. In such instances, partial cancellation penalties may apply. Also, when the advertiser 102 requests to modify a single flight, that specific flight may be re-estimated independently. All other reservations are retained.

Determining the distribution setting 243 can also include applying these and other redistribution rules when modifying the one or more campaign parameters includes adding/removing one or more dayparts and/or DOW. When the advertiser 102 requests to add one or more new dayparts without removing any of the original dayparts (and the budget has not been increased), the advertiser can also specify a desired weighting and overflow to be applied to the newly added dayparts, including overflow. Based on the indicated weighting for the new dayparts, the system can re-distribute impressions from all existing dayparts to account for the newly added daypart.

For example, assume that four original impressions include: 6:00 AM to 10:00 AM, 10:00 AM to 3:00 PM, 3:00 PM to 7 PM, and 7 PM to Midnight. Also assume that these four original impressions were assigned 35% (or 3,5000 impressions), 15% (or 1,500 impressions), 25% (or 2,500 impressions) and 25% (2,500 impressions) respectively of the total 10,000 impressions. When the advertiser 102 requests to add a fifth daypart (e.g., Overnights) and requests 10% weight for the Overnights daypart, the requested 10% is evenly removed from the four original dayparts and added into the newly added Overnight daypart. The result is that (1) the 6:00 AM to 10:00 AM daypart is now assigned 31.3% or 3,150 impressions; (2) the 10:00 AM to 3:00 PM day part is now assigned 22.5% or 1,350 impressions; (3) the 3:00 PM to 7 PM daypart is now assigned 22.5% or 2,250 impressions; (4) the 7 PM to Midnight daypart is now assigned 22.5% or 2,250 impressions; and (5) the Overnights daypart is now assigned 10% or 1,000 impressions (350 from 6:00 AM to 10:00 AM, 150 from 10:00 AM to 3:00 PM, 250 from 3:00 PM to 7 PM, and 250 from 7 PM to Midnight.)

When the advertiser 102 requests to add one or more new dayparts and remove one or more original dayparts, the advertiser can specify the desired weighting for the newly added dayparts, including overflow. The system can first re-distribute the displaced impressions from the removed daypart to the newly added daypart, to the extent that the re-distribution yields approximately the requested weighting. When the displaced impressions from the removed dayparts are less than the number of impressions requested to be added to the new daypart (based on the requested weighting), the system can re-distribute additional impressions to new dayparts according to previous example. When the total number of the displaced impressions exceed the number of impressions requested to be added or available in the new daypart, the system can re-distribute any available additional impressions across the remaining original dayparts evenly, according to overflow. When the advertiser 109 requests to remove one or more daypart without adding another daypart, the system can re-distribute the displaced impressions from the removed dayparts evenly across the remaining original dayparts, according to overflow.

Alternatively, when detected that the advertiser 109 requested to remove one or more dayparts and reduce the overall budget accordingly, partial cancellation penalties may apply. When the detected modification includes request from the advertiser 109 to add one or more dayparts and increase the overall budget, the advertiser is prompted to re-enter weightings and overflow for all dayparts (new and original). The system displays the number (or percentage) of impressions remaining to deliver. The advertiser 109 may modify the weightings for any or all of the dayparts. The system may give preference to the already reserved inventory and re-distribute the displaced impressions from any removed dayparts as necessary and according to the specified overflow to accommodate new weighting values.

Alternatively, the advertiser 109 may modify the one or more campaign parameters to increase or decrease the number (or percentage) of impressions remaining for any daypart without changing the overall budget. When the advertiser 109 initiates a modification to one or more of the existing original dayparts, the system can display the number (or percentage) of impressions remaining to deliver in all dayparts. The advertiser 109 may modify the weightings for any or all of the dayparts. The system may give preference to the already reserved inventory and re-distribute any displaced impressions as necessary and according to overflow to accommodate new weighting values. When the number (or percentage) of impressions remaining are reduced to decrease the overall budget, partial cancellation penalties may apply. These re-distribution schemes described with respect to the daypart modification are also application when the DOW is modified (e.g., added or removed).

Determining the distribution setting 243 can also include applying these and/or other redistribution rules when modifying the one or more campaign parameters includes increasing or decreasing the overall budget. When the detected modification includes the advertiser 109 initiating a budget increase in conjunction with or as a result of any other campaign parameter modification (e.g., adding a market), the system the set of rules detailed with respect to the modification of such campaign parameter modification (e.g., market, daypart, DOW, format, station, dates, flights, etc.). When the detected modification includes advertiser 109 initiated budget increase independent of a modification to any other campaign parameters, the system prompts the advertiser 109 to enter new overflow inputs for the daypart, DOW and market. The system may apply additional impressions across all campaign parameters, according to distribution settings and overflow, to accommodate the overall budget. When the detected modification includes advertiser initiated budget decrease in conjunction with or as a result of one or more modifications to any other campaign parameters, the system follows the rules detailed with respect to the modified campaign parameters (e.g., market, daypart, DOW, format, station, dates, flights, etc). When the advertiser 109 initiates a budget decrease independent of any other campaign parameter modification, the system can release the reserved inventory across all campaign parameters, according to distribution settings and overflow, to accommodate the requested modification. In such instances, partial cancellation penalties may apply.

In the above described and/or other modifications to the campaign parameters (e.g., add or remove markets), the overflow parameters specified by the advertiser 102 at the time of the modification are applied only to the newly added inventory.

The distribution of impressions may also take into account makegoods. When a broadcast station does not run an ad during a specifically scheduled ad spot, a make-up ad spot, or makegood, may later be provided. In addition, a makegoods option may be provided when an ad spot does not deliver as many impressions as estimated.

At 236, the advertiser module 122 determines whether there has been a budget change. Increasing the budget allocates more money to purchase more impressions, while decreasing the budget means that fewer impressions are available for distribution. A budget may be modified automatically by the advertiser module 122 in conjunction with other parameter modifications, or may be manually modified by the advertiser 102. When the budget has changed, the number of impressions available for distributions is updated at 238. After the number of available distributions has been updated at 238 or if the budget has not changed at 236, the impressions are redistributed at 240 according to the distribution settings determined at 234.

At 242 the advertiser 102 may have the option of generating an estimate of how the modifications have affected the distribution of impressions among the selected parameter. It is also possible for the estimate generation to be automatic. When the advertiser 102 wants an estimate to be generated, estimates and reports are generated at 244.

After an estimate has been generated or not, the advertiser 102 has the option of undoing the modifications at 246. When the advertiser 102 wants to undo the modifications, the advertiser 102 may select a parameter at 232. Otherwise, the advertiser 102 may be given the option to modify another parameter or to further modify the existing parameter at 248. When the advertiser 102 wants to modify a parameter, this is done at 232.

At 250, the advertiser 102 is provided with the option of applying the modifications to the associated previously booked ad campaign. When detected that the modifications are to be applied the associated previously booked ad campaign, the advertiser module 122 applies the modifications to the ad campaign at 252 while the ad campaign is still running and/or without releasing any previously reserved ad spots. When the advertiser module 122 has finished applying the modifications and determines that an ad spot is no longer necessary, the unnecessary ad spot is released.

FIG. 2C depicts a flowchart of the redistribution process at 240 in FIG. 2B. At 262, the advertiser module 122 determines the distribution settings. At 264, the advertiser module 122 determines whether the impressions are already properly distributed among the parameter according to the distribution settings. When detecting that a proper distribution is not present, the impressions are redistributed according to the distribution settings at 266. Afterwards, the advertiser 102 may have the option of manually distributing the impressions if so desired at 268 and implementing this redistribution at 270, giving the advertiser 102 an opportunity to further optimize its ad campaign.

FIG. 3 is an illustration of an exemplary graphical user interface 300 presented to the advertiser 102. As described with respect to FIG. 2A, the advertiser 102 can input parameter data using a graphical user interface such as the one illustrated in FIG. 3. The graphical user interface 300 displays one or more parameter sections 310, 320, and 330, corresponding to the various parameters available and relevant to a corresponding ad campaign. The one or more parameter sections 310, 320, and 330 may be displayed on the same screen or on different screens. Each of the one or more parameter sections 310, 320, and 330 may contain one or more input fields or other input methods to enable the advertiser 102 to input the desired parameter information. Further, the graphical user interface includes one or more display regions for presenting information to the advertiser. The advertiser 102 may access the graphical user interface 300 using an Internet browser or through a client-installed application.

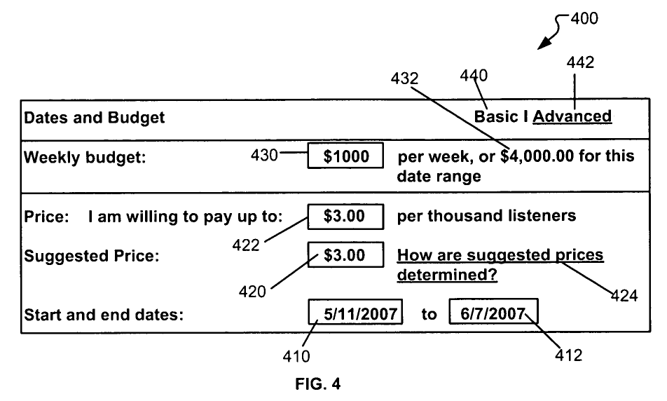

FIGS. 4-9 illustrate some of the parameters that can be presented through one or more of the campaign parameter sections 310, 320 and 330. FIG. 4 depicts a budget parameter section 400, corresponding to one of the parameter sections 310, 320, and 330. The budget parameter section 400 depicts the use of user input fields and identifying labels for the user input fields. The advertiser 102 can input a campaign start date into input field 410 and a campaign end date into input field 412. Suggested price output field 420 displays a suggested price per block of impressions. This suggested price is calculated by the advertiser module 122 in the inventory management system 120. The advertiser 102 can input the maximum amount that the advertiser 102 is willing to pay per block of impressions into price input field 422. Suggested price information link 424 provides a link to information about how the advertiser module 122 determines suggested prices. This provides additional information for the advertiser 102 to consider when determining a value to place into price input field 422. Budget input field 430 enables the advertiser 102 to input the amount of money that it wants to spend per week on the ad campaign. Budget output field 432 displays the total budget for the ad campaign by using the data entered into date input fields 410 and 412. Although budget input field 432 is designated to take a weekly budget as an input, it is possible for budget input field 432 to instead be used for budgets of other time durations, such as daily budgets, biweekly budgets, monthly budgets, or yearly budgets. Basic 440 and advanced 442 buttons provide flexibility to budget parameter section 400 by providing a basic budget parameter section 400 for less advanced advertisers 102 while enabling advanced advertisers 102 to access advanced features to further optimize their ad campaign.

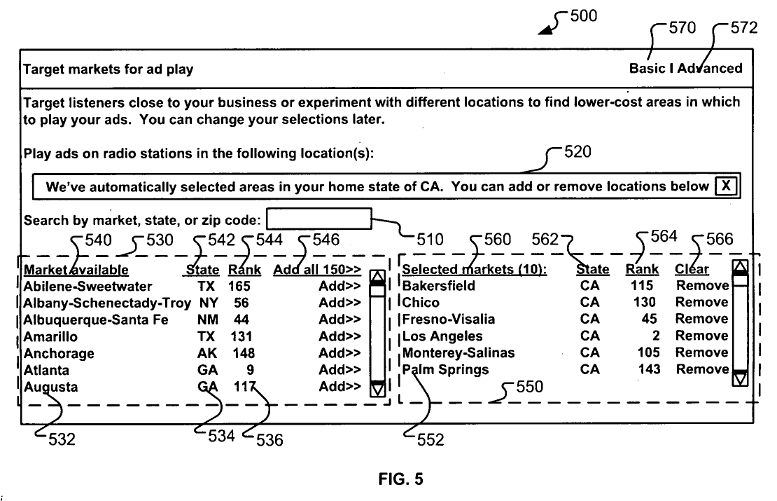

FIG. 5 depicts market parameter section 500, corresponding to one of the parameter sections 310, 320, and 330. The market parameter section 500 depicts the use of sortable and selectable tables as ways of inputting information concerning an ad campaign. For example, location input field 510 enables the advertiser 102 to input a market, state, or zip code to search for available markets. Other implementations of location input field 510 may enable the advertiser 102 to input different types of geographic locations, such as cities or countries. Message bar 520 may alert the advertiser 102 that certain markets have been pre-selected. Input elements such as basic 570 and advanced 572 buttons provide flexibility to market parameter section 500 by providing a basic market parameter section 500 for less advanced advertisers 102 while enabling advanced advertisers 102 to access advanced features to further optimize their ad campaign.

Market input table 530 displays the available markets 532, the state that a market is in 534, the market rank 534 that is determined by the advertiser module 122, and an “add” 538 button for adding the available market to the table of selected markets 550. Each column in the market input table 530 is also sortable. The available markets can be sorted alphabetically by clicking on the “Markets available” button 540, by state by clicking on the “State” button 542, or by rank by clicking on the “Rank” button 544. In addition, an “Add all” button 546 can be provided to enable the advertiser to add all of the available markets to the selected markets table 550. Other implementations of the market input table 530 may have sortable columns other than that of state and rank, such as number of broadcast stations, population, or demographic information.

Selected markets table 550 contains all of the markets that have already been selected, either by the advertiser 102 manually selecting each market from market input table 530 or from the advertiser module 122 pre-selecting markets based location input field 510. Analogous to market input table 530, selected markets table 550 displays the selected markets 552, the state that a market is in 554, the market rank 554 that is determined by the advertiser module 122, and a “remove” 558 button for removing the selected market from the table of selected markets 550. Each column in the selected markets table 550 is also sortable. The selected markets can be sorted alphabetically by clicking on the “Selected markets” button 560, by state by clicking on the “State” button 562, or by rank by clicking on the “Rank” button 564. In addition, a “Clear” button 566 can be provided to enable the advertiser 102 to clear all of the available markets from the selected markets table 550. Other implementations of the market input table 550 may have sortable columns other than that of state and rank, such as number of broadcast stations, population, or demographic information.

The budget parameter section 400 and the market parameter section 500 are representative of the one or more parameter sections 310, 320, and 330. Other parameter sections can also be provide to enable user selection and modification of other parameters such as station formats, broadcast stations, time spots, day spots, and target demographic.

The budget parameter section 400 and the market parameter section 500 illustrate only some of the different types of input tools that the graphical user interface may use. In some implementations, other combinations of user input elements can be provided to enable user selection and modification of various parameters. Other options may include, but are not limited to: radio buttons, drop-down menus, and slide bars.

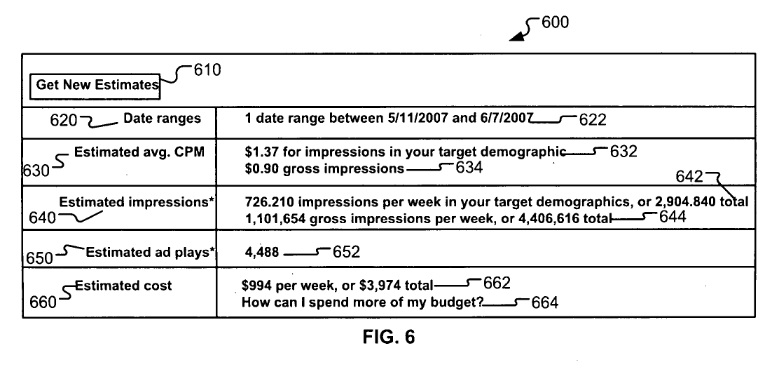

FIG. 6 depicts a parameter section pertaining to an ad campaign estimator 600, corresponding to one of the parameter sections 310, 320, and 330. Ad campaign estimator 600 includes various output fields. Ad campaign estimator update button 610 enables the advertiser 102 to update the estimates at any time. For example, the date range row 620 displays the corresponding date range for the ad campaign estimate. Estimated average impression price row 630 displays the cost per thousand impressions for the target demographic 632 and also the gross cost per thousand impressions 634. Although the units in estimated average impression price row 630 are in price/thousand impressions, other implementations may use other potential price units such as price/impression, price/hundred impressions, or price/ten thousand impressions. In some implementations, other potential price units may include cost per point (CPP). Estimated impressions row 640 displays the estimated number of impressions per time period (e.g., week) for the target demographic and in total 642, as well as the gross estimated number of impressions per time period (e.g., week) for the target demographic and in total 644. Estimated ad plays row 650 displays the estimated number of times an ad will be played during the date range displayed in date range row 620. Estimated cost row 660 displays the estimated cost of the ad campaign per time period (e.g., week) and in total 662. Estimated cost row 660 also displays an information link 664 that enables the advertiser 102 to read additional information about how to better maximize the use of its budget. The ad campaign estimation information disclosed by the ad campaign estimator 600 is not limited to the rows disclosed by FIG. 6. Other possibilities include rows for estimated average impressions/ad play, as well as more detailed estimates per market, station format, day spot, time spot, or any other parameter.

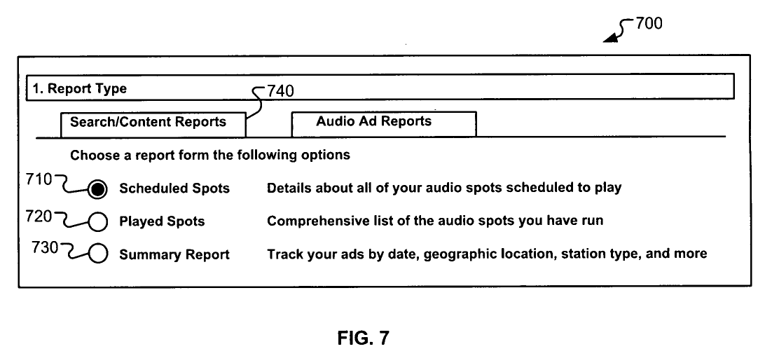

FIG. 7 depicts an exemplary parameter section pertaining to an ad campaign report generator 700, corresponding to one of the parameter sections 310, 320, and 330. Ad campaign report generator section 700 gives the advertiser 102 the option of generating reports related to the scheduled spots 710, the ad spots that have already been played 720, or a detailed summary report 730. These reports are also searchable at 740. Other types of reports are also possible. These reports may contain statistical data such as spill markets, local rating points, frequency by market, and frequency by station. The display of this statistical data is not limited to forms or tables, but also may appear in the form of charts or graphs. This data may enable the advertiser 102 to determine how well the ad campaign is performing according to the already specified parameters and to determine if the ad campaign needs to be modified.

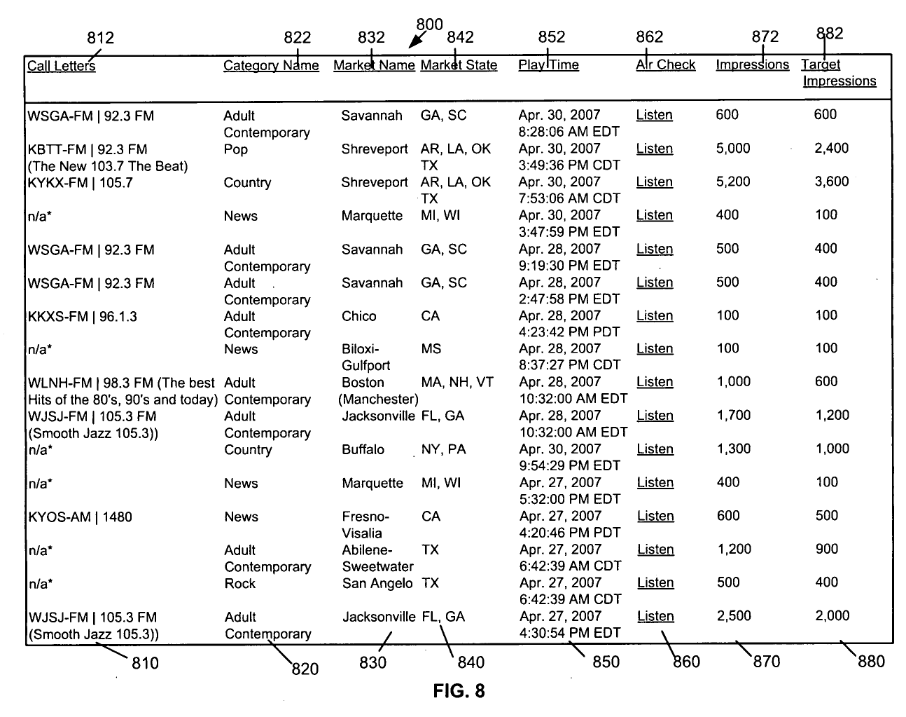

FIG. 8 depicts an exemplary report 800 illustrating a list of previously aired ad spots. This report provides statistics regarding previously aired ad spots. For example, call letter column 810 displays the call letters for each radio station. Category name column 820 displays the station format. Market name column 830 displays the market of the radio station. The market state column 840 displays the state or states in which the market is located. The play time column 850 displays the date and time that the ad aired. The air check column 860 enables the advertiser 102 to listen to the ad that was aired. The impressions column 870 displays the gross number of impressions. The target impressions column 880 displays the number of impressions of the targeted demographic. The gross impressions to target impressions ratio is useful when trying to optimize the ad campaign to use the most efficient markets, station formats, radio stations, etc. Spots report 800 may contain more columns relating to other statistics or may contain less columns if desired. Each column of spots report 800 may also be sortable using sortable links 812, 822, 832, 842, 852, 862, 872, and 882.

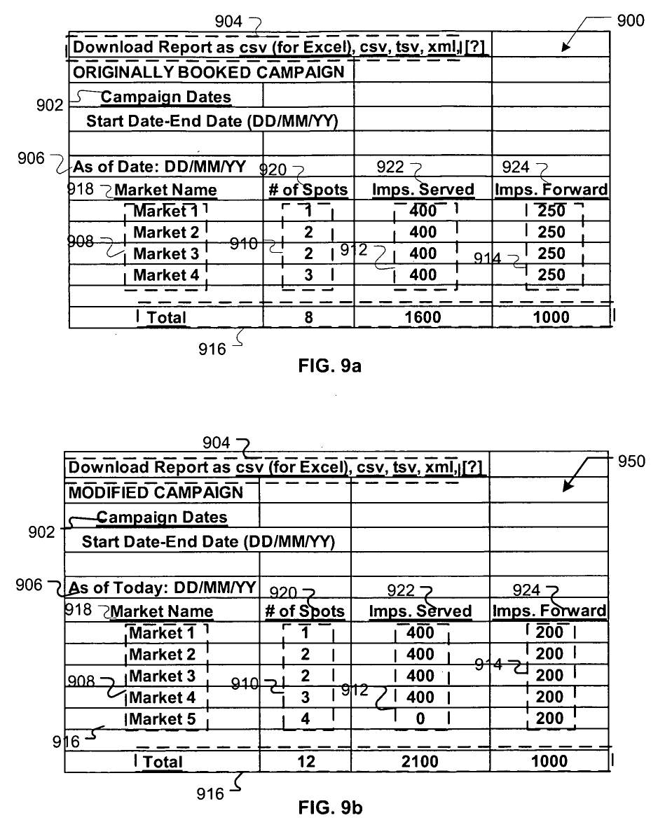

FIG. 9a illustrates an example summary report 900. The detailed summary report 900 enables the advertiser 102 to track and manage its ad campaign by tracking both played and future ad spots for the originally booked campaign. Among others, the report 900 provides information regarding the originally booked campaign, such as the originally booked campaign dates 902. The report 900 also provides a list of the originally booked markets 908; a list of the originally booked spot 920 for the originally booked markets 908; and a list of number of impressions already served 912 for each of the originally booked markets 908. The list of the number of already served impressions 912 is current as of the displayed Date 906. The report also provides a list of the estimated number of impressions still left to be served 914. By entering a specific “as of date” 906, the advertiser 102 can receive the report 900 that describes the impressions served as of the entered date and the remaining impression to be served. Other information can be provided to the advertiser 102 for viewing, such as the running total for the number of spots, impressions served, impressions to be served, etc. Summary report 900 may contain more user-interactive columns relating to other statistics or may contain fewer columns if desired. Each column of summary report 900 may also be sortable using sortable links 918, 920, 922, and 924. Reports may also be downloaded in several different formats using the download links 904.

FIG. 9b illustrates another example summary report 950. The detailed summary report 950 enables the advertiser 102 to track and manage its ad campaign by tracking both played and future ad spots for the originally booked campaign and after the campaign has been modified. For example, FIG. 9b illustrates a modification by the advertiser 102 to add a market (market 5). The added market 5 is shown in the list of markets 908 and a visual indication 914 is provided to identify the newly added market. While FIG. 9b shows the visual indication 916 as a box, other visual indications such as highlighting, bolding, underlining, etc. can be applied. Because market 5 has been newly added, the number of impressions already served 922 is displayed as “0” impressions. Also, because market 5 has been added without deleting any of the original markets 1-4, the impressions remaining to be delivered from the original markets 1-4 (400 impressions from each) are re-distributed across all of the markets (new and original). Thus, after the modification of adding a market without deleting any of the market, the number of impressions to be delivered 924 for each market is approximately 200 impressions. In the example shown in FIGS. 9a and 9b, a uniform distribution is assumed. Additional reporting options can be provided, such as providing a report that shows only the revised portion of the campaign. Also, similar reports can be generated when other campaign parameters are modified.

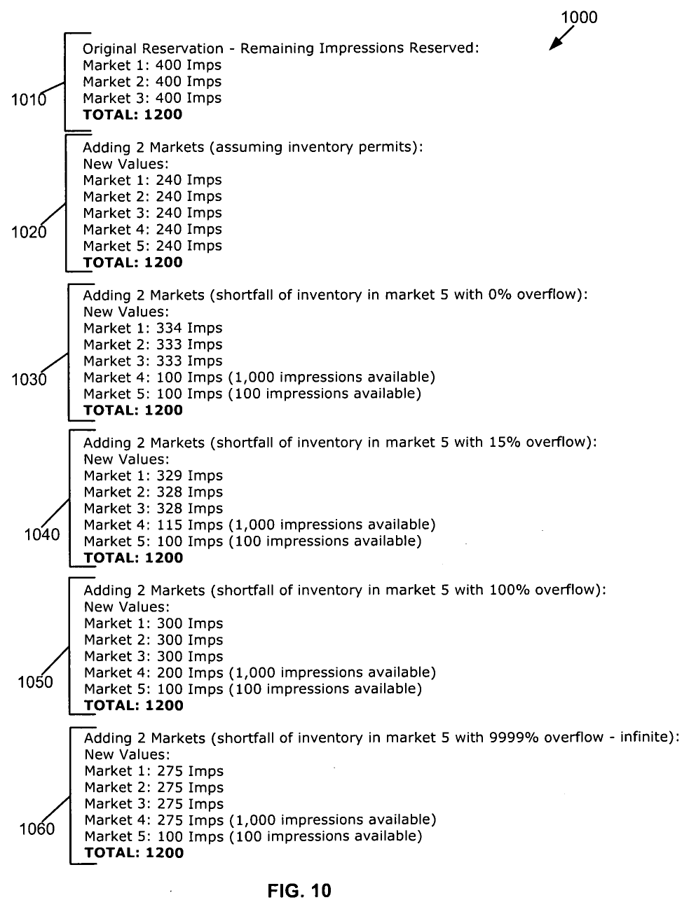

FIG. 10 illustrates a possible implementation of an overflow rate when using a weighting system to redistribute the remaining impressions that have not yet been delivered (i.e., corresponds to not yet aired ad spots). The overflow rate allows an advertiser to specify the maximum amount by which the distribution of the remaining impressions can deviate from a selected distribution scheme (assuming the available inventory supports the overflow rate.) For example, when the selected distribution is uniform distribution, the overflow rate determines the amount by which the distribution can deviate from an uniform distribution. The following examples describe the use of overflow rate when modifying a previously booked campaign. Data set 1010 shows the original reservation of ad spots in a previously booked ad campaign. For example, assume that the previously booked ad campaign originally included 3 markets with total of 2100 impressions targeted evenly among the three markets. Data set 1010 shows the originally selected 3 markets with 1200 impressions still remaining to be delivered. Thus, those ads that have already aired have captured 900 impressions already. That leaves each market with 400 allocated impressions remaining to be delivered in the previously booked campaign.

Data set 1020 illustrates the scenario where 2 markets are added, no markets are removed, and that the distribution settings dictate that the impressions should be evenly distributed among the markets. Data set 1030 illustrates the scenario where 2 markets are added, no markets are removed, market 5 has an inventory shortage, and the overflow rate is set to 0% by the advertiser. In this scenario, assume that due to the inventory shortage, the total number of available ad spots in market 5 is down to 100 impressions. Since the overflow rate is set to 0%, the advertiser is not willing to deviate from the selected distribution rules. Thus, assuming that the distribution rules dictate that the same number of impressions must be distributed to each new market added, both markets 4 and 5 are allocated 100 impressions each, even though market 4 has an impression surplus. Because the overflow rate is set at 0% by the advertiser, the number of impressions purchased in market 4 cannot be increased beyond the selected uniform distribution even though there are surplus ad spots available in market 4.

Data set 1040 illustrates the scenario described by data set 1030, except that there is a 15% overflow rate selected by the advertiser. This 15% overflow rate means that the advertiser is willing to accept up to 15% deviation from the selected distribution (uniform distribution in this scenario). Thus, the number of impressions purchased in market 4 can be increased (by 15%) beyond the selected uniform distribution dictated by the distribution rules. In other words, by using the overflow rate, the advertiser can take advantage of the inventory surplus (e.g., 1,000 impressions) available in market 4 and purchase an additional 15% of the impressions available in the surplus. This results in allocating 115 impressions to market 4 and 100 impressions to market 5. Similarly, data set 1050 shows that the overflow rate is set to 100% by the advertiser. Thus, the advertiser can purchase 200 more impressions (100% overflow of 100 impressions is 200) in market 4. Data set 1060 illustrates the use of an infinite overflow rate. At data set 1060, the advertiser can buy all available impressions in market 5, and the remaining impressions are distributed evenly among markets 1-4.

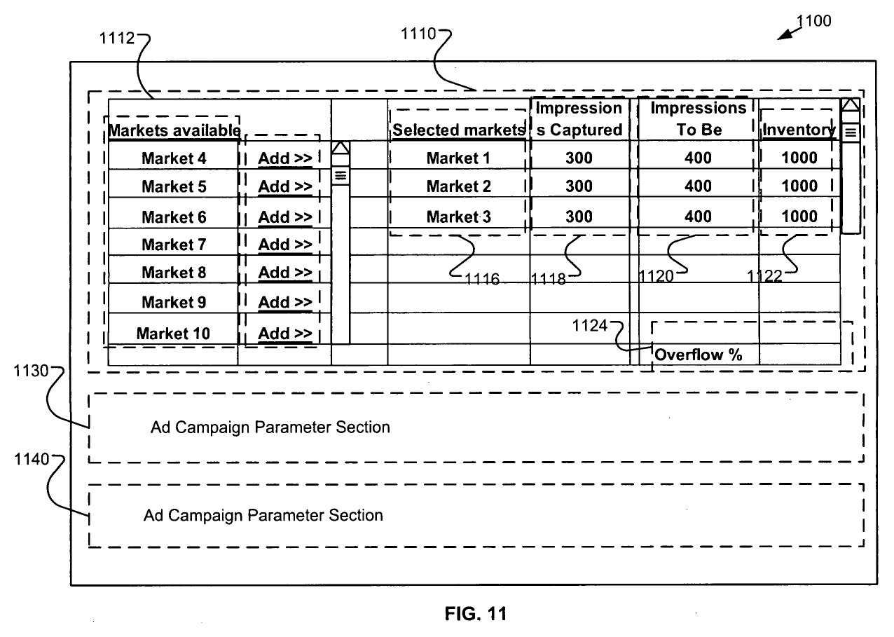

FIG. 11 illustrates an exemplary graphical user interface 1100 for enabling an advertiser to select and modify one or more campaign parameters. For example, the advertiser 109 is presented with visual indication that shows what has been delivered (e.g., number of impressions per market), what is remaining to be delivered, etc. The advertiser 109 can physically modify those remaining distributions manually (e.g., budget, rating points by market, impressions, etc. In addition, FIG. 11 shows an exemplary GUI input area 1124 that enables the advertiser 109 to select and/or modify an overflow rate, among other campaign parameters. For example, the graphical user interface 1100 includes various ad campaign parameter sections 1110, 1130 and 1140 designed to receive from an advertiser, selection and/or modification of various ad campaign parameters. For example, a first campaign parameter section 1110 can be designed to enable an advertiser to select and/or modify one or more target markets. The “Available markets” display section 1112 is used to present a list of available markets to the advertiser. When one or more desired markets are identified, the advertiser can select the one or more desired markets by interfacing (e.g., single or double clicking with a mouse cursor) with the “Add>>” user selectable element 114 (e.g., a button). The selected one or more markets are displayed in the “Selected markets” display section 116. Alongside each selected market, various statistics can be displayed. For example, the number of already captured impressions (i.e., corresponding to already aired air spot) can be displayed in the “Impressions captured” display section 1118. The number of impressions captured can enable the advertiser to determine an approximate portion of the previously booked campaign that has been completed.

Also, the “Impressions to be delivered” display/edit section 1120 can be used to display the remaining number of impressions yet to be captured (corresponding to the ad spots that have not yet aired.) When the advertiser modifies the previously booked campaign (e.g., adds or deletes one or more markets), the number of impressions to be delivered changes based on the distribution rule and the overflow rate selected by the advertiser (as described with respect to FIG. 10.) The advertiser can enter a desired overflow rate into the overflow selection section 1124. The overflow selection section 1124 can be a user input box, a drop down menu (that provides a list of percentage choices), a radio button, etc. Further, the available inventory (e.g., number of available ad spots) for each selected market can also be displayed to the user using the “Inventory” display section 1122. The advertiser is not required to enter an overflow rate, and leaving the overflow rate 1124 blank can be detected as being equivalent to entering “0” as the desired overflow rate.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal, that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what may be claimed, but rather as descriptions of features that may be specific to particular implementation. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Only a few implementations have been described, and other variations are possible. For example, When modifications to the booked campaign is made by the advertiser 102, the inventory management system (IMS) 120 can be designed to hold existing reservations, and only release or re-distributing spots directly affected by the modification. When re-distribution of advertising impressions is detected to be needed, the IMS 120 can be designed to favor the original reservations and only “shuffle” or redistribute the inventory to the extent necessary to accommodate the modification. Original reservations can be honored strictly and held throughout all modification iterations until a new schedule is saved.

In addition, modifications can be applied to strictly honor all declines that were initiated before and since the original campaign was booked, both in revised estimates and playout.

Overflow parameters that are indicated during the modification can be treated as being separate from the original settings. For example, the overflow settings indicated at the time of a campaign modification may pertain only to newly added inventory (in the case of adding inventory), or the % by which displaced inventory is re-distributed (in the case of removing inventory), to minimize impact on original reservations. In other words, the original overflow parameters may become irrelevant (not followed) at the time of the modification because the original overflow parameters can be assumed to set to guide spot distribution at the time of initial booking only. The delivery-to-date, at the time of editing, is already reflective of those goals.

Makegoods function can be implemented to supersede the modification process. For example, all missed impressions (due to lost spots) can be carried over into the revised campaign for makegood, according to modified campaign parameters. This may necessitate lost spots be made good on different station(s) or in different dayparts, etc. In such cases, the system may evaluate replacement spots according to price, efficiency and distribution goals.

All modifications can take into consideration Reach & Frequency. For example, IMS may return frequency calculation for a campaign by market, by week, etc.

Also, a GUI can be implemented to display total and remaining budget on the modification page(s). The advertiser 102 may modify the remaining budget according to the rules described in this specification and total budget can be re-calculated accordingly.

During the modification process, various Spot Details reports can be made available for export each time a user re-estimates prior to saving their revisions. A first Spot Detail report can reflect the total campaign, including what's already served to date plus what is estimated for the future, according to the modification. A second Spot Detail report can reflect only the modified period. At any time, if the advertiser cancels, the system times out, or the modifications are for any reason not saved, the original scheduled campaign is held and unchanged. Once a modified schedule is saved and new spots can be reserved or released according to the modification. In some implementations, a total of three Spot Detail reports can be made available after a modification. (1) The original, (2) The total revised (old+new), and (3) The revised period only (next day forward).

In addition to these variations, other modifications are possible and within the scope of the following claims.

What is claimed is:

1. A computer-implemented method comprising:
selecting one or more parameters from among a plurality of parameters associated with an previously booked broadcast media ad campaign;
modifying the selected one or more parameters; and
applying the one or more modified parameters to the previously booked broadcast media ad campaign while the broadcast media ad campaign is running.

2. The method of claim 1, wherein the selecting comprises selecting one or more of a geographic market, a station format type, a campaign duration, a time interval of the campaign, a time spot, a day spot, a station tier type, and a target demographic.

3. The method of claim 1, further comprising modifying the selected one or more parameters without releasing one or more reserved ad spots.

4. The method of claim 1, further comprising applying the modified parameters in an auction ad campaign.

5. The method of claim 1, further comprising determining a desired number of estimated ad listeners to be captured by the previously booked broadcast media ad campaign, and assigning a percentage of the desired number to each of the parameters.

6. The method of claim 5, wherein performing the assigning comprising using a uniform weighting system.

7. The method of claim 5, further comprising obtaining a budget for the previously booked broadcast media ad campaign, wherein the obtained budget is modifiable to increase or decrease the desired number.

8. The method of claim 5, further comprising when detected that the selected one or more parameters are modified, redistributing the desired number among the parameters based on one or more rules.

9. The method of claim 5, further comprising generating one or more reports that describe at least the percentage of the desired number assigned to each of the parameters.

10. A computer program product, encoded on a computer-readable medium, operable to cause a data processing apparatus to perform operations comprising:
selecting one or more parameters from among a plurality of parameters associated with a previously booked broadcast media ad campaign;
modifying the selected one or more parameters; and
applying the one or more modified parameters to the previously booked broadcast media ad campaign while the previously booked broadcast media ad campaign is running.

11. The computer program product of claim 10, further operable to cause the data processing apparatus to perform operations comprising selecting one or more of the parameters from a group that includes a geographic market, a station format type, a campaign duration, a time interval of the campaign, a time spot, a day spot, a station tier type and a target demographic.

12. The computer program product of claim 10, further operable to cause the data processing apparatus to perform operations comprising modifying the selected one or more parameters without releasing one or more reserved ad spots.

13. The computer program product of claim 10, further operable to cause the data processing apparatus to perform operations comprising applying the modified parameters in an auction ad campaign.

14. The computer program product of claim 10, further operable to cause the data processing apparatus to perform operations comprising determining a desired number of estimated ad listeners to be captured by the previously booked broadcast media ad campaign and assigning a percentage of the desired number to each of the parameters.

15. The computer program product of claim 14, further operable to cause the data processing apparatus to perform operations comprising the percentage of the desired number of estimated ad listeners to each of the parameters based on a uniform weighting system.

16. The computer program product of claim 14, further operable to cause the data processing apparatus to perform operations comprising obtaining a budget for the previously booked broadcast media ad campaign that, wherein the obtained budget is modifiable to increase or decrease the desired number.

17. The computer program product of claim 14, further operable to cause the data processing apparatus to perform operations comprising when detected that the selected one or more parameters are modified, redistributing the desired number among the parameters based on one or more rules.

18. The computer program product of claim 14, further operable to cause the data processing apparatus to perform operations comprising generating one or more reports that includes at least information regarding the percentage of the desired number assigned to each parameter.

19. A system comprising:
a user interface; and
one or more computers coupled to the user interface, the one or more computers including a display and a processor configured to provide a graphical user interface that includes
a parameter selector operable to receive a user selection of one or more parameters from among a plurality of parameters associated with a previously booked broadcast media ad campaign; and
a parameter modification region operable to receive a user modification of the selected one or more parameters; and
wherein the one or more computers are configured to apply the received user modification to the previously booked broadcast media ad campaign while the previously booked broadcast media ad campaign is running.

20. The system of claim 19, wherein the one or more computers are further configured to provide the parameter selector to enable user selection of one or more parameters from a group that includes a geographic market, a station format type, a campaign duration, a time interval of the campaign, a time spot, a day spot, station tier type, and a target demographic.

21. The system of claim 19, wherein the one or more computers are further configured to provide the parameter modification region to enable user modification of the selected one or more parameters without releasing one or more reserved ad spots.

22. The system of claim 19, wherein the one or more computers are further configured to apply the received user modification in an auction ad campaign.

23. The system of claim 19, wherein the one or more computers are further configured to
determine a desired number of estimated ad listeners to be captured by the previously booked broadcast media ad campaign; and
assign a percentage of the desired number to each parameter.

24. The system of claim 23, wherein the one or more computers are further configured to distribute the desired number of estimated ad listeners among the parameters based on a uniform weighting system.

25. The system of claim 23, wherein the one or more computers are further configured to provide the parameter selector to receive a user selected budget for the previously booked broadcast media ad campaign, wherein the received budget is modifiable to increase or decrease the desired number.

26. The system of claim 23, wherein the one or more computers are further configured to redistribute the determined desired number among the parameters based on one or more rules when detected that the one or more selected parameters are modified.

27. The system of claim 23, wherein the one or more computers are further configured to generate one or more reports that include information concerning the percentage of the desired number assigned to each parameter.

28. A system comprising:
a display means for presenting a graphical user interface operable to receive a user selection of one or more parameters from among a plurality of parameters associated with a previously booked broadcast media ad campaign; and
a processing means for
modifying the selected one or more parameters; and
applying the modified one or more parameters to the previously booked broadcast media ad campaign while the previously booked broadcast media ad campaign is running.
